(19) United States
(12) Patent Application Publication
(10) Pub. No.: US 2020/0009585 A1
(43) Pub. Date: Jan. 9, 2020

(54) COMBINATION SHAKE AND SPRAY BOTTLE

(71) Applicant: Kathryn S Garrison, Laguna Hills, CA (US)

(72) Inventor: Kathryn S Garrison, Laguna Hills, CA (US)

(21) Appl. No.: 16/028,898

(22) Filed: Jul. 6, 2018

(51) Int. Cl. B05B 1/14; B65D 47/20

(52) U.S. Cl. CPC B05B 1/14; B65D 47/20

(57) ABSTRACT

A multipurpose shake or spray bottle container may include an upper liquid dispenser unit sized to accommodate a volume of a liquid; a spray nozzle attached to the upper liquid dispenser unit and designed to dispense the liquid from the upper liquid dispenser unit; a lower solids dispenser unit sized to accommodate a volume of at least one solid, the lower solids dispenser attached to the upper liquid dispenser by a divider designed to keep the liquid separate from the at least one solid; and a sifter attached to a surface of the lower solids dispenser unit, the sifter designed to dispense the at least one solid from the lower solids unit. The lower solids dispenser unit may be partitioned into multiple solids compartments to accommodate a plurality of solid materials.

### BACKGROUND

The embodiments described herein relate generally to containers, and more particularly, to a combination shake and spray bottle.

Conventionally, there is no easy way to carry around and easily use (via shaking or spraying) three separate household products being used simultaneously. For example, vinegar, salt, and baking soda are commonly used together in a variety of chores and cleaning tasks. It is necessary to store these products separately until use, but it is inconvenient to gather each produce, pour, measure, and carry each individually.

Therefore, what is needed is a combination shake and spray bottle that is designed to separately store multiple products, while also providing a simple and easy way to carry the products around together and apply to surfaces, as needed.

### SUMMARY

Some embodiments of the present disclosure include a multipurpose shake or spray bottle container may include an upper liquid dispenser unit sized to accommodate a volume of a liquid; a spray nozzle attached to the upper liquid dispenser unit and designed to dispense the liquid from the upper liquid dispenser unit; a lower solids dispenser unit sized to accommodate a volume of at least one solid, the lower solids dispenser attached to the upper liquid dispenser by a divider designed to keep the liquid separate from the at least one solid; and a sifter attached to a surface of the lower solids dispenser unit, the sifter designed to dispense the at least one solid from the lower solids unit. The lower solids dispenser unit may be partitioned into multiple solids compartments to accommodate a plurality of solid materials.

### BRIEF DESCRIPTION OF THE FIGURES

The detailed description of some embodiments of the invention is made below with reference to the accompanying figures, wherein like numerals represent corresponding parts of the figures.

FIG. 1 is a side elevation view of one embodiment of the present disclosure.

FIG. 2 is a side elevation view of one embodiment of the present disclosure, shown in use.

FIG. 3 is an exploded side elevation view of one embodiment of the present disclosure.

FIG. 4A is a cross-sectional view taken along line 4A-4A in FIG. 1.

FIG. 4B is a cross-sectional view taken along line 4B-4B in FIG. 2.

FIG. 4C is a cross-sectional similar to FIG. 4A.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as a combination shake and spray bottle and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

1. Spray Nozzle

2. Upper Liquid Dispenser Unit

3. Divider

4. Lower Solid Dispenser Unit

5. Sifter

6. Dispenser Handle and Actuating Lever

The various elements of the device of the present disclosure may be related in the following exemplary fashion. It is not intended to limit the scope or nature of the relationships between the various elements and the following examples are presented as illustrative examples only.

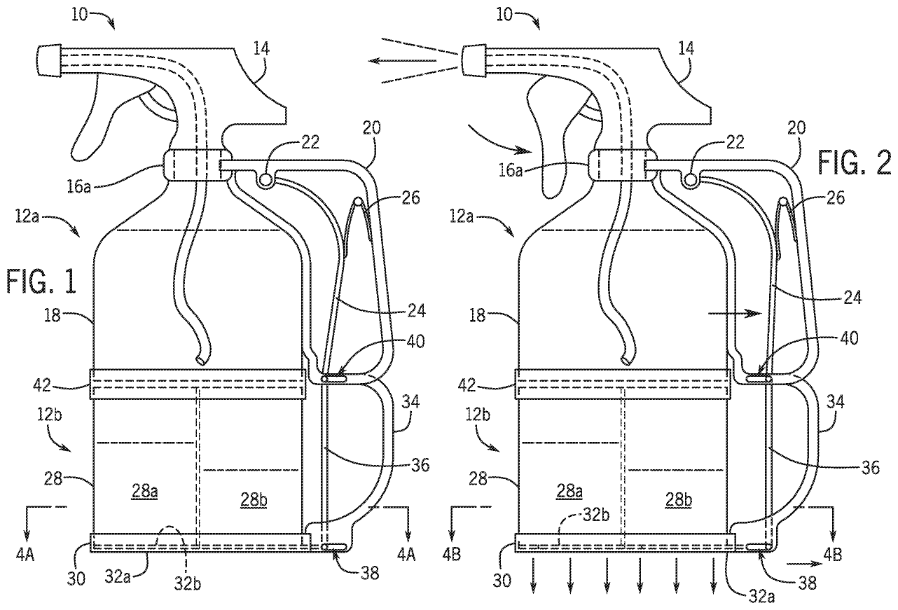

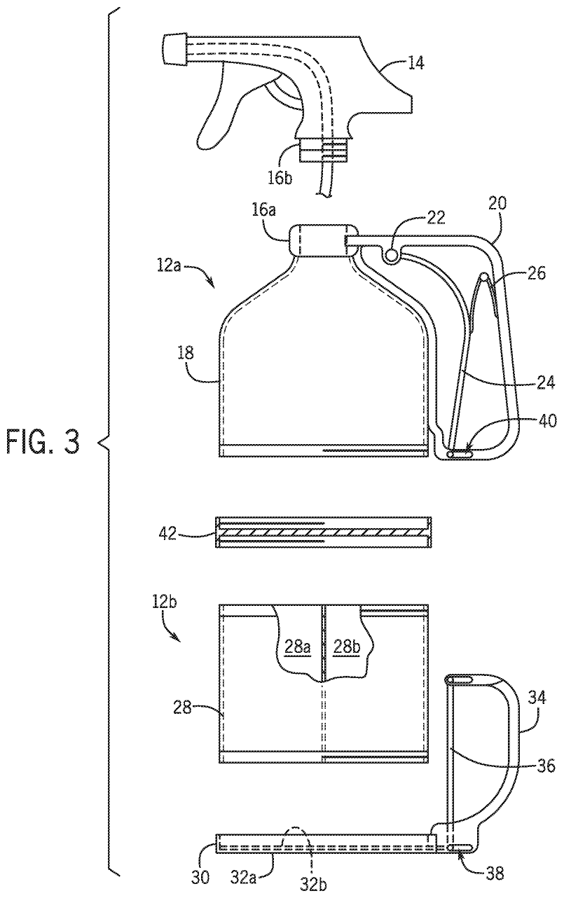

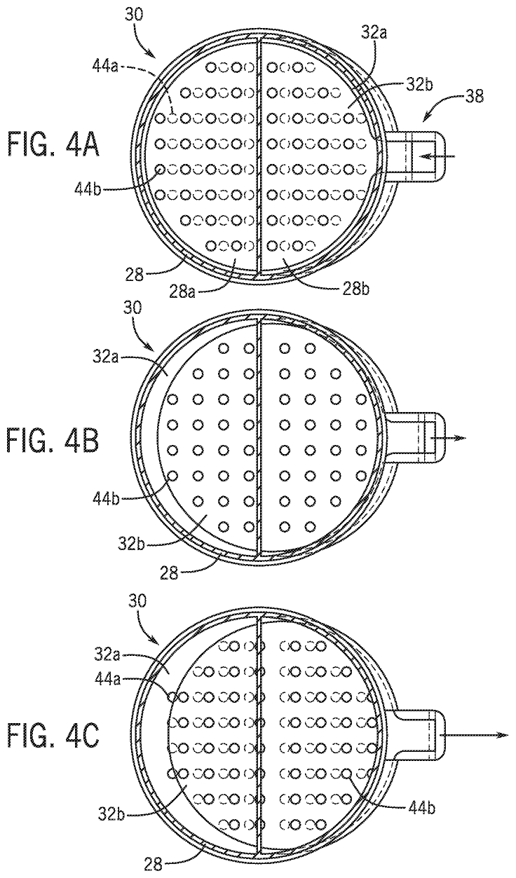

By way of example, and referring to FIGS. 1-4C, some embodiments of the present disclosure include a multipurpose shake or spray bottle container 10 comprising an upper liquid dispenser unit 12a sized to accommodate a volume of a liquid, the upper liquid dispenser unit 12a designed to dispense the liquid; a lower solids dispenser unit 12b sized to accommodate a volume of at least one solid, the lower solids dispenser unit 12b designed to dispense the at least one solid; and a divider 42 attaching the lower solids dispenser unit 12b to the upper liquid dispenser unit 12a while keeping the liquid separate from the at least one solid.

The upper liquid dispenser unit 12a may comprise a liquid container 18 sized to accommodate the volume of liquid, the liquid container 18 having a neck, such as a threaded neck 16a, designed to engage with a nozzle connection point, such as a threaded nozzle connection 16b. The lower solids dispenser unit 12b may comprise a solids container 28 sized to accommodate the volume of at least one solid operatively attached to the sifter. The solids container 28 may be designed to accommodate a single solid material or, by introducing partitions into the solids container 28, the solids container may be separated into a plurality of solids compartments such as a first solids compartment 28a and a second solids compartment 28b. The solids container 28 may attach to the sifter via any known connection means, such as screwing, snapping, or the like. As mentioned above, the upper liquid dispenser unit 12a may be attached to the lower solids dispenser unit 12b by a divider 42.

The sifter, as described above, may attach to a bottom surface of the solids container 28. The sifter may comprise a base plate 32a rigidly secured to a sifter body 30 and a sifter plate 32b slidably secured within the sifter body 30. The base plate 32a may comprise a plurality of base plate orifices 44a extending therethrough, and the sifter plate 32b may comprise a plurality of sifter plate orifices 44b extending therethrough, wherein the orifices 44a, 44b have a size sufficient to allow passage of grains or other pieces of the solid material therethrough. When the multipurpose container 10 is in a resting position (i.e., when the actuating lever is not compressed), the sifter plate orifices 44b may be offset from the base plate orifices 44a. On the other hand, when the actuating lever 24, 36 is compressed, the orifices 44a, 44b may align, allowing the passage of solid material therethrough, thus dispensing the solid material from the solid container 28 through the sifter and onto the desired surface.

As shown in the Figures, the multipurpose container 10 may comprise a spray nozzle 14 to dispense the liquid from the upper liquid dispenser unit 12a and a sifter to dispense the at least one solid from the lower solid dispenser unit 12b. The spray nozzle 14 may comprise a substantially conventional spray nozzle 14 with a tube leading down into the upper liquid dispenser unit 12a and a trigger that, when squeezed, pulls the liquid up from the upper liquid dispenser unit 12a through the nozzle 14 and out onto the desired surface.

The multipurpose container 10 may further comprise a dispenser handle operatively attached to the sifter to provide for dispensing of the at least one solid through the sifter. The dispenser handle may comprise an upper dispenser handle 20 attached to the neck 16a and an actuating lever 24 pivotally attached to a handle pivot 22 proximate to the neck 16a. The actuating lever 24 may also be connected to a slide connector 40 positioned distal from the neck 16a. A tensioning/return spring 26 may be positioned between the actuating lever 24 and the upper dispenser handle 20, such that the spring 26 causes the actuating lever 24 to be positioned toward the liquid container 18 unless the actuating lever 24 is compressed by a user.

The dispenser handle may further comprise a lower dispenser handler 34 extending upward from the sifter and, when the multipurpose container bottle 10 is assembled, running alongside the solids container 28. A lower actuating lever 36 may be slidably mounted to the lower dispenser handle 34 at lower slide connector 38. The lower actuating lever 36 may be attached to the actuating lever 24 at slide connector 40. Slide connector 38 may also be attached to the sifter plate 32b such that, when the slide connector 38 slides away from the lower solids dispenser unit 12b, the sifter plate 32b also slides within the sifter to align sifter plate orifices 44b with base plate orifices 44a, allowing the solid material within the solids container 28 to be dispensed onto the desired surface. Thus, when either the actuating lever 24 or the lower actuating lever 36 is compressed by a user, the sifter dispenses solid material from the solids container 28 onto the desired surface.

The multipurpose container 10 of the present disclosure may be made of any desired or suitable materials.

To use the multipurpose container 10 of the present disclosure, a user may fill the liquid container 18 with the desired liquid, such as vinegar, and attach the spray nozzle 14 thereto. The solids container 28 may be filed with the desired solids, such as salt and baking soda, and the sifter may be attached to a bottom of the solids container 28. The lower solids dispenser unit 12b may be attached to the upper liquid dispenser unit 12a by the divider 42. The liquid may be dispensed from the liquid container 28 by squeezing the trigger on the spray nozzle 14, and the solids may be dispensed from the solid container 28 by compressing the actuating lever 24, 36.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A multipurpose shake or spray bottle container comprising:
an upper liquid dispenser unit sized to accommodate a volume of a liquid;
a spray nozzle attached to the upper liquid dispenser unit and designed to dispense the liquid from the upper liquid dispenser unit;
a lower solids dispenser unit sized to accommodate a volume of at least one solid, the lower solids dispenser attached to the upper liquid dispenser by a divider designed to keep the liquid separate from the at least one solid; and
a sifter attached to a surface of the lower solids dispenser unit, the sifter designed to dispense the at least one solid from the lower solids unit.

2. The multipurpose shake or spray bottle container of claim 1, wherein the sifter comprises:
a sifter body;
a base plate mounted to the sifter body, the base plate comprising a plurality of base plate orifices extending therethrough; and
a sifter plate slidably mounted within the sifter body, the sifter plate comprising a plurality of sifter plate orifices extending therethrough.

3. The multipurpose shake or spray bottle container of claim 2, further comprising a dispenser handle operatively attached to the upper liquid dispenser unit and to the sifter, wherein:
at least one actuating lever is slidably mounted to the dispenser handle and to the sifter plate, such that when the at least one actuating lever is compressed, the sifter plate slides within the sifter body, aligning the sifter plate orifices with the base plate orifices.

4. The multipurpose shake or spray bottle container of claim 3, wherein the dispenser handle comprises:
an upper dispenser handle attached to the upper liquid dispenser unit;
an actuating lever pivotally attached to a handle pivot proximate to an upper area of the upper liquid dispenser unit;
a lower dispenser handle extending upward from the sifter;
a lower actuating lever slidably mounted within the lower dispenser handle and mounted to the sifter plate; and
a slide connector attached to the actuating lever and the lower actuating lever.

5. The multipurpose shake or spray bottle container of claim 1, wherein the lower solids dispenser unit comprises a solid container designed to accommodate the volume of the at least one solid.

6. The multipurpose shake or spray bottle container of claim 5, wherein the solid container comprises at least one partition, thus defining a plurality of solids compartments within the solid container.
